(19) United States
(12) Patent Application Publication
(10) Pub. No.: US 2007/0193119 A1
(43) Pub. Date: Aug. 23, 2007

(54) POWER DRIVE WINDOW ACTUATOR

(75) Inventor: Lawrence Andrew Hoffman, Portland, OR (US)

Correspondence Address: PAUL J. FORDENBACHER;SILICON FOREST PATENT GROUP, 11876 NW TYLER CT., PORTLAND, OR, 97229, US

(73) Assignee: The Hoffman Group, LLC, Portland, OR (US)

(21) Appl. No.: 11/621,114

(22) Filed: Jan. 8, 2007

Related U.S. Application Data
(62) Division of application No. 10/891,307, filed on Jul. 12, 2004, now abandoned.
(60) Provisional application No. 60/518,129, filed on Nov. 4, 2003.

(51) Int. Cl. E05F 11/48

(52) U.S. Cl. 49/352

(57) ABSTRACT

Embodiments of the present invention provide power drives comprising a drive unit, a drive cable, a trolley, and a track on which a trolley is guided for moving components for use in motor vehicle applications. The drive unit comprises a gear powered by an electric motor. The electric motor rotates the gear that meshes with and advances the drive cable. The drive unit is coupled to an end of the track by an intermediate cable sleeve comprising a flexible material allowing for independent placement of the drive unit and the track by selectively bending the intermediate cable sleeve. The drive cable passes through the intermediate cable sleeve and is coupled to the trolley and is adapted to advance the trolley along the track. The electric motor causes the gear to rotate in a forward or reverse direction to advance the trolley along the track.

### RELATED APPLICATION

This application is a Division of and claiming the benefit of U.S. non-provisional application Ser. No. 10/891,307 filed Jul. 12, 2004, and U.S. provisional patent application No. 60/518,129, filed Nov. 4, 2003, the entire disclosures of which are hereby incorporated by reference as if set forth in its entirety for all purposes.

### FIELD OF THE INVENTION

This invention generally relates to power drives for motor vehicles, and more particularly, power drives for use in confined locations such as in a door frame to raise and lower a window.

### BACKGROUND OF THE INVENTION

Power-driven components are becoming commonplace in motor vehicles as customers demand comfort and convenience. Power windows, door locks, doors, and hatches are either standard or optional equipment on many of today's cars and trucks. Customers are also looking to aftermarket components to convert manual operation components to power-driven operation.

Power windows are standard equipment in many new motor vehicles today. The ease of pressing a button over turning a crank to raise and lower the side windows of a motor vehicle has lead to the availability of conversion kits to provide power windows to motor vehicles equipped with manual crank window winders.

One type of manual crank window winder consists substantially of a linkage mechanism coupled to the window and driven by a crank-operated gear assembly. As the crank rotates the gear assembly, a gear drives a linkage arm that causes the linkage mechanism to raise or lower the window. One type of powered window winder provides an electric motor in the place of the manual crank.

A power drive is needed that can be located in small body cavities or spaces. Such a power drive is needed not only for use in power window actuator applications but also for other applications on a motor vehicle where a power drive is desired.

### SUMMARY OF THE INVENTION

Embodiments of the present invention provide power drives comprising a drive unit, a drive cable, a trolley, and a track on which a trolley is guided for moving components for use in motor vehicle applications. The drive unit comprises a gear powered by an electric motor. The electric motor rotates the gear that meshes with and advances the drive cable. The drive unit is mounted on an end of the track. The drive cable is coupled to the trolley and is adapted to advance the trolley along the track. The electric motor causes the gear to rotate in a forward or reverse direction to advance the trolley along the track.

In accordance with another embodiment of the present invention, the drive unit is mounted independently from the track so as to reduce the overall length, among other things. The drive unit is coupled to a cable guide on the track by an intermediate cable sleeve. The intermediate cable sleeve guides the drive cable from the drive unit and is coupled to the trolley and is adapted to advance the trolley along the track. The electric motor causes the gear to rotate in a forward or reverse direction to advance the trolley along the track.

Another embodiment in accordance with the present invention provides a power drive comprising a drive unit, a trolley, and a track on which a trolley is guided for operating a window of a motor vehicle. The drive unit comprises a gear powered by an electric motor. The motor rotates the gear that meshes with and advances the drive cable. The drive unit is mounted independently from the track. The drive cable is coupled to the trolley and is adapted to advance the trolley along the track. The electric motor causes the gear to rotate in one direction to advance the trolley forward and up the upwardly extending track, raising and closing the window. The electric motor causes the gear to rotate in the reverse direction to drive the trolley in the opposite direction lowering and opening the window.

In accordance with another embodiment of the present invention, the drive unit is mounted independently from the track so as to be located in the close confines within a door panel. The drive unit is coupled to a cable guide on the track by an intermediate cable sleeve. The intermediate cable sleeve guides the drive cable from the drive unit and is coupled to the trolley and is adapted to advance the trolley along the track. The electric motor causes the gear to rotate in a forward or reverse direction to advance the trolley along the track.

In another embodiment in accordance with the present invention, a power drive comprising a drive unit, a drive cable, a trolley, and a track on which a trolley is guided for operating a tonneau cover of a motor vehicle is provided. The drive unit comprises a gear powered by an electric motor. The motor rotates the gear that meshes with and advances the drive cable. The drive unit is mounted independently from the track. The drive cable is coupled to the trolley and is adapted to advance the trolley along the track. The electric motor causes the gear to rotate in one direction to advance the trolley forward and up the upwardly extending track, raising an arm pivotally coupled to the cover, pushing the cover open. Reversing the direction of travel of the trolley from a higher position to a lower position lowers the arm and closes the cover.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

These and other embodiments are described in more detail in the following detailed descriptions and the figures.

The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1 is a top view of a power drive for use in a powered window assembly, in accordance with an embodiment of the present invention;

FIG. 2A is a top view of a power drive for use in motor vehicle applications, in accordance with an embodiment of the present invention;

FIG. 2B is a top view of a power drive, in accordance with another embodiment of the present invention.

FIGS. 3A and 3B are cross-sectional views of a track and trolley, in accordance with an embodiment of the present invention;

FIG. 4 is a cut-away view of a drive unit, in accordance with an embodiment of the present invention;

FIG. 5 is a rear perspective view of a power-driven tonneau cover actuator, in accordance with an embodiment of the present invention;

FIG. 6 is a rear perspective view of a power-driven tonneau cover actuator, in accordance with an embodiment of the present invention;

FIG. 7 is a top view of the power-driven tonneau cover actuator of FIG. 6; and

FIG. 8 is a perspective view of a power window actuator, in accordance with another embodiment of the present invention.

### DETAILED DESCRIPTION OF THE INVENTION

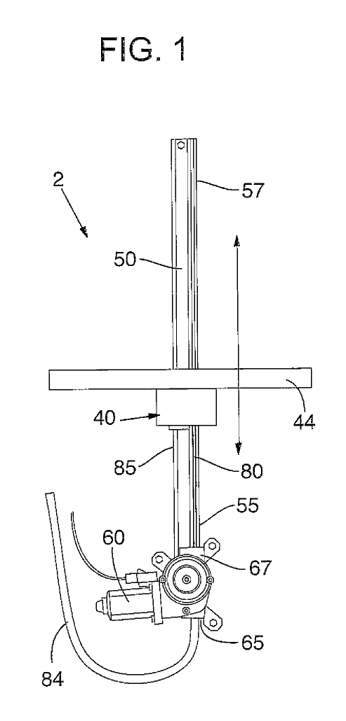

Representative embodiments of the present invention are shown in FIGS. 1 through 8 wherein similar features share common reference numerals. U.S. Pat. No. 6,623,096, titled Power Tonneau Cover Actuator, is incorporated by reference into this disclosure as if fully set forth herein.

In the following detailed description, reference is made to the accompanying drawings which form a part hereof wherein like numerals designate like parts throughout, and in which is shown by way of illustration specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

FIG. 1 is a top view of a powered window assembly 2 that replaces a gear assembly and linkage mechanism of a manual crank window assembly with a motor-driven track and trolley mechanism. A drive unit 60, comprising an electric motor and gears, is coupled to a track lower end 55 of a track 50. The drive unit 60 advances a worm gear (not shown) that is coupled to a drive cable 80 having a cable distal end 85 coupled to a trolley 40. The trolley 40 is coupled to the bottom of a window (not shown) with a window flange 44 suitable to couple with the window. An electric switch activates the drive unit 60. As the trolley 40 raises and lowers along the track 50, the window also raises and lowers within a window frame, closing and opening the window.

In many cases, the powered window mechanism 2 is located within a door or body cavity that can have limited space. The body cavity may not be large enough in the vertical dimension to accommodate the overall length of the powered window mechanism 2, necessitating the use of a shorter track 50. A shorter track 50 limits the excursion of the window, potentially leaving the window in a partially raised position when open. This space limitation is functionally and aesthetically undesirable.

This space limitation is particularly acute in conversion situations where a manual mechanism is being replaced by the powered window mechanism 2. The linkage mechanism of the manual crank window winder can be accommodated within a body cavity with a substantially smaller vertical dimension versus the requirements of the powered window mechanism 2. Therefore, the available space may preclude conversion to a powered window.

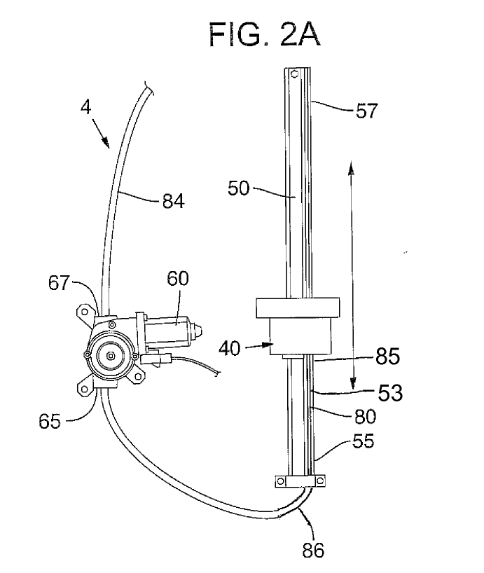

FIG. 2A is a top view of a power drive 4 for use in motor vehicle applications in accordance with an embodiment of the present invention. The power drive 4 is particularly suitable where there is limited space to accommodate the drive unit being coupled to the track. The drive unit 60 is mounted independently from the track 50 so as to reduce the overall length of the power drive 4, among other things, as compared with the embodiment of FIG. 1. The power drive 4 comprises a drive unit 60, a trolley 40, a track 50, a drive cable 80, an intermediate cable sleeve 86, and a distal cable sleeve 84. The drive unit 60 comprises an electric motor that rotates a drive cable gear, details of which are discussed below. The drive cable gear meshes with and advances the drive cable 80 through the drive unit 60.

The drive cable 80 comprises a distal end 85 that is coupled to the trolley 40 and a proximal end (not shown) that is proximate the drive unit 60. The track 50 comprises a track lower end 55, a track upper end 57, and a drive cable guide 53. The drive cable guide 53 extends from the track lower end 55 to the track upper end 57, and is adapted to guide the drive cable 80 along the track 50. The trolley 40 and track 50 are coupled to allow for sliding engagement of the trolley 40 along the length to the track 50.

The drive unit 60 is coupled to the cable guide 53 by the intermediate cable sleeve 86. The drive unit 60 comprises a drive proximal end 65 and a drive distal end 67. The drive cable 80 extends from the drive unit 60 at both the drive proximal end 65 and the drive distal end 67. The intermediate cable sleeve 86 comprises a tubular member having a lumen with an internal diameter of sufficient dimension to accommodate the passage of the drive cable 80 therethrough. One end of the intermediate cable sleeve 86 is coupled to the drive cable guide 53 at the track lower end 55, and the other end of the intermediate cable sleeve 86 is coupled to the drive proximal end 65. The drive cable 80 extends from the drive unit 60 through the intermediate cable sleeve 86 and into the drive cable guide 53.

The distal cable sleeve 84 comprises a tubular member having a lumen with an internal diameter of sufficient dimension to accommodate the passage of the drive cable 80 therethrough. One end of the distal cable sleeve 84 is engaged with the drive unit 60 at the drive distal end 67. A drive cable proximal end (not shown) of the drive cable 80 partially extends from the drive distal end 67 and into the distal cable sleeve 84; the distal cable sleeve 84 adapted to contain the drive cable 80 therein when the drive cable 80 is in the retracted position where the trolley 40 is adjacent the track lower end 55.

In one embodiment in accordance with the present invention, the intermediate drive cable sleeve 86 and/or the distal drive cable sleeve 84 comprise substantially rigid and/or inelastic tubing. The substantially rigid tubing comprises a material that can be substantially plastically formed or bent into a desired predetermined configuration, such as, but not limited to, straight, curves, and spirals, to guide the drive cable 80 without substantial restriction. The substantially rigid tubing is adapted to provide smooth drive cable operation while protecting the drive cable 80 from, for example, but not limited to, crushing, abrasion, and/or the environment. The substantially rigid tubing provides for pre-forming the intermediate drive cable sleeve 86 and/or the distal drive cable sleeve 84 suitable for a particular installation allowing for placement of the drive unit 60 in a desired location independent of the location of the track 50.

In another embodiment in accordance with the present invention, the intermediate drive cable sleeve 86 and/or the distal drive cable sleeve 84 comprise substantially flexible tubing. The substantially flexible tubing comprises a material that can be substantially elastically formed and held, or otherwise allow for unrestricted positioning into a desired predetermined configuration, such as, but not limited to, straight, curves, and spirals, to guide the drive cable 80 without substantial restriction. The substantially flexible tubing is adapted to provide smooth drive cable operation while protecting the drive cable 80 from, for example, but not limited to, crushing, abrasion, and/or the environment. The substantially flexible tubing allows, for example, but not limited to, flexibility of placement of the drive unit 60 in relationship to the track 50 during installation.

In another embodiment in accordance with the present invention, the intermediate drive cable sleeve 86 and the distal drive cable sleeve 84, each, comprise either substantially flexible tubing or substantially rigid tubing as described above.

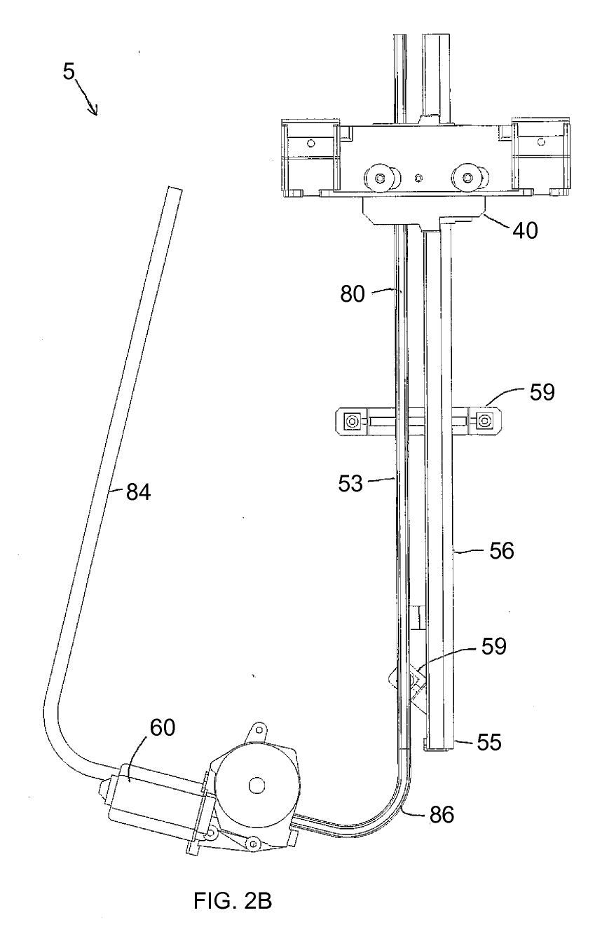

It is appreciated that the intermediate drive cable sleeve 86 and the distal drive cable sleeve 84 can have many configurations suitable for guiding the drive cable 80 on a predetermined path. Suitable configurations comprise, among others, a semicircular track, substantially similar to the semi-circular drive cable guide 53 shown in FIG. 3B, and a square cross-section channel.

The electric motor of the drive unit 60 causes the drive cable gear (described below) to rotate in one direction to advance the drive cable 80, and therefore the trolley 40, in one direction along the track 50, and rotate in a reverse direction to advance the drive cable 80, and therefore the trolley 40, in a reverse direction.

FIGS. 3A and 3B are cross-sectional views of the track 50 and trolley 40, in accordance with an embodiment of the invention. The track 50 comprises an elongated channel having a trolley guide flange 51 on one edge and a drive cable flange 52 on an opposite edge. The trolley guide flange 51 is adapted to couple with a trolley guide bearing 41 to provide for secure attachment as well as a guide for linear translational movement of the trolley guide bearing 41. The trolley guide flange 51 provides an L-shaped guide that provides these attributes. Other flange shapes suitable for the particular purpose are anticipated.

The cable guide flange 52 provides a corner support and mounting structure for a semi-circular drive cable guide 53. The drive cable guide 53 provides a protective structure as well as a guide for the movement of the drive cable 80 along the track 50. The drive cable guide 53 extends substantially the entire length of the track 50, but at least so far are to accommodate the fully-extended drive cable 80. The exposed portion of the drive cable 80 provided along the length of the drive cable guide 53 provides access by a trolley/cable mount 46 which will be described below.

The trolley 40 comprises a mounting plate 42 and the trolley guide bearing 41. The trolley guide bearing 41 is adapted to couple in sliding engagement with the trolley guide flange 51 as discussed above. The trolley guide flange 51 guides the trolley 40 along the length of the track 50.

The mounting plate 42 is coupled to the trolley guide bearing 41 and provides a mounting platform for an object to be moved by the power drive 4. Suitable fasteners may be used to couple the object to the trolley 40.

The mounting plate 42 further comprises a drive cable mount 46. The drive cable mount 46 is adapted to securely couple with the drive cable 80. The drive cable 80 pushes and pulls the trolley 40 along the track 50 requiring a secure engagement between the trolley 40 and the drive cable 80. In one embodiment, the drive cable mount 46 is one or more projecting members that couple with and embed into the drive cable 80. Other mounting methods suitable for the particular purpose are anticipated.

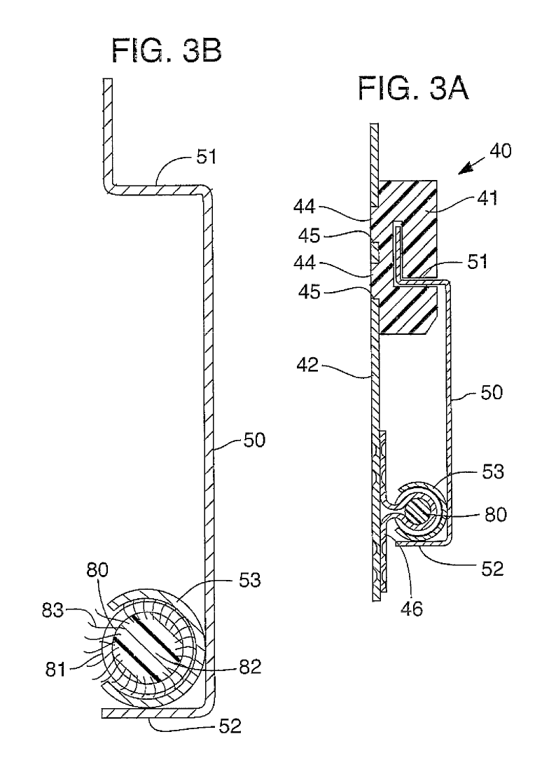

FIG. 4 is a cut-away view of the drive unit 60 comprising an electric motor 62 and a motor-driven gear 77, in accordance with an embodiment of the invention. The drive unit 60 is adapted to couple with the drive cable 80 to advance and retract the drive cable 80 along the drive cable guide 53 while carrying the trolley 40 along the trolley guide flange 51. The drive cable 80 is sufficiently flexible for installation considerations while sufficiently stiff to drive the trolley 40 without kinking or binding. In one embodiment in accordance with the invention, the drive cable 80 comprises a helical coil 81 of stiff wire with a stiffening core 82 covered with bristle 83 inserted therein. The helical coil 81 is not only flexible, but also provides regularly spaced openings for meshing with teeth 79 of the drive gear 77. The bristle 83 extends through the openings of the helical coil 81. The bristle 83 provides a number of beneficial features, such as, but not limited to, keeping dirt and the like from entering the gear 77 and drive cable guide 53, maintaining the spacing between the loops of the helical coil 81, as well as providing a bearing to center the drive cable 80 along the respective travel paths. The stiffening core 82 adds stiffness to the helical coil 81 preventing compression, collapse, or kinking of the helical coil 81.

It is understood that the drive cable 80 and drive gear 77 may be of various known configurations suitable for the particular purpose. Example configurations include, but not limited thereto, drive cables having threads, teeth, and/or links.

FIG. 2B is a top view of a power drive 5 for use in motor vehicle applications, in accordance with another embodiment of the present invention. The power drive 5 comprises a drive unit 60, a trolley 40, a track 56, a drive cable 80, an intermediate cable sleeve 86 and a distal cable sleeve 84. The track 56 further comprises a cable guide 53 coupled to the track with cross braces 59. The power drive 5 is substantially similar in function as the embodiment of the power drive 4 as shown in FIG. 2A.

Power Tonneau Cover

One embodiment of the present invention provides a power-driven tonneau cover actuator for operating a tonneau cover for a truck bed of a truck, such as a pickup truck. A common tonneau cover includes, but is not limited to, a fiberglass panel that overlies the truck bed. The tonneau cover is typically hingably coupled to a distal end of the truck bed adjacent the truck cab. The power-driven tonneau cover actuator comprises a power drive with an actuator arm pivotally coupled to the trolley. The power-driven tonneau cover actuator is secured to the inside surface of a sidewall of the truck bed proximal to the opening end of the cover and distal to the hinge coupling. The track is positioned at an angle to the horizontal extending in an upward direction towards the hinged coupling. The other end of the actuator arm is pivotally coupled to the inside of the cover. A drive unit is provided for translating the trolley along the track. The drive unit advances the trolley along the track from a track lower end to a track upper end that raises the arm to push the cover open. Reversing the direction of travel of the trolley from the track upper end to the track lower end lowers the arm and closes the cover.

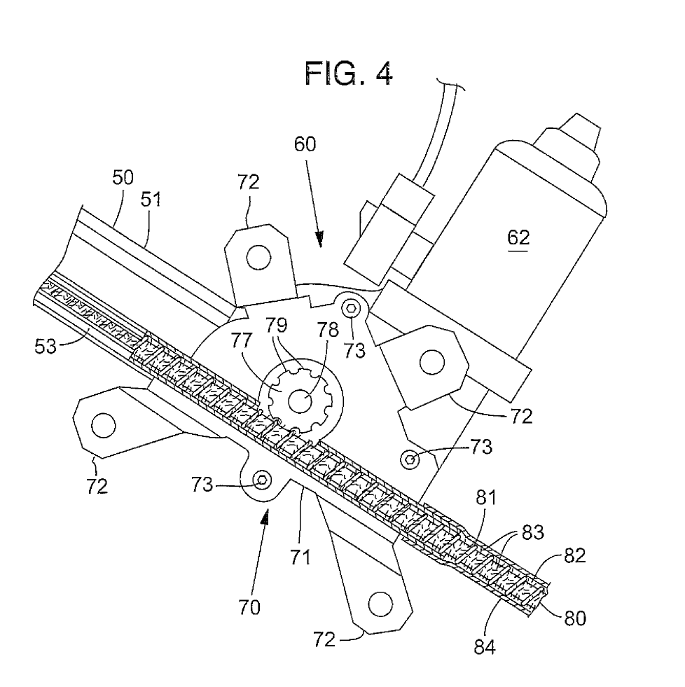

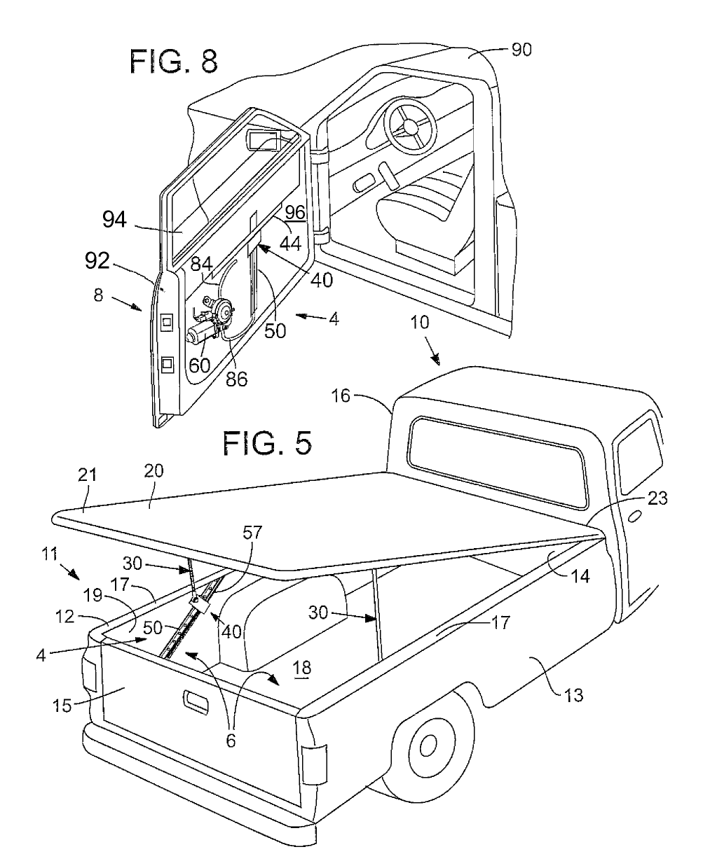

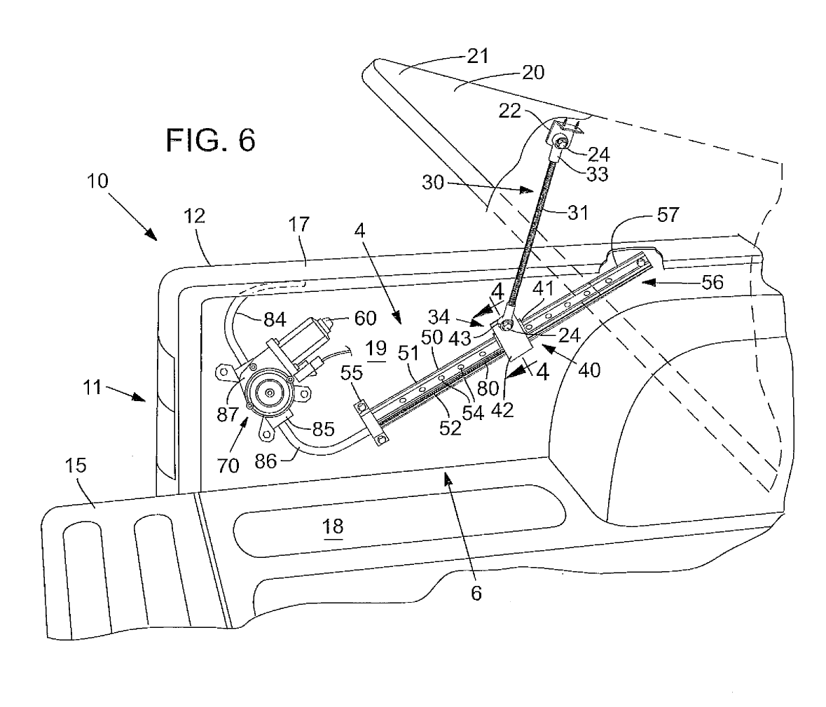

FIGS. 5 and 6 are rear perspective views, and FIG. 7 is a top view of a power-driven tonneau cover actuator 6 mounted in a pickup truck 10. A truck bed 11 is defined by a bed floor 18, upstanding opposite body side panels 12, 13, a tailgate 15, and a front panel 14 adjacent the driver's cab 16. The tonneau cover 20 comprises a one-piece molded fiberglass reinforced plastic panel that is sized to overlie the top rim 17 of the side panels 12, 13, front panel 14, and tailgate 15 so as to cover same when the tonneau cover 20 is in the lowered closed position. The tonneau cover 20 can be made of other materials such as, but not limited to, sheet metal, and other configurations, such as, but not limited to, multiple panels.

In accordance with an embodiment of the present invention, the power-driven tonneau cover actuator 6 is mounted on the inside surface 19 of one of the side panels 12, 13 proximal to the opening end 21 of the cover 20 and distal to the hinge coupling 23. In another embodiment, one power-driven tonneau cover actuator 6 is used on each of the side panels 12, 13. The lift arm 30 is pivotally coupled to the trolley 40 at one end and pivotally coupled to the cover 20 at the other end. The power-driven tonneau cover actuator 6 opens the tonneau cover 20 in a manner to be raised above the bed 11 at the tailgate 15 to provide access to the tailgate 15 and sides 12, 13 of the truck bed 11 and to be lowered to a closed position enclosing the rim 17 of the bed 11.

The power-driven tonneau cover actuator 6 comprises a power drive 4, substantially as shown in FIG. 2A, and an arm 30. The track 50 of the power drive 4, is positioned at an angle to the horizontal extending in an upward direction with the track upper end 57 towards the hinged coupling 23 with the track lower end 55 lower than the track upper end 87. The drive unit 60 advances the trolley 40 along the track 50 from the track lower end 55 to the track upper end 57, which raises the arm 30 to push open the tonneau cover 20 from a lower position “A” to a higher position “B”. Reversing the direction of travel of the trolley 40 from the track upper end 57 to the track lower end 55 lowers the arm 30 and closes the tonneau cover 20.

The arm 30 is pivotally coupled to the trolley 40 at one end and the tonneau cover 20 at the other end. The movement of the trolley 40 from the track lower end 55 to the track upper end 57 pivotally translates the arm 30 raising the tonneau cover 20.

The arm 30 comprises a linkage rod 31 coupled to an upper coupling member 33 on one end and a lower coupling member 35 on the other end. The coupling members 33, 35 are coupled to the linkage rod 31 in any of a number of suitable methods known, including, but not limited to, by threaded coupling, welding, and the like. The upper and lower coupling members 33, 35 include a mounting joint adapted to pivot about a bolt 24 passing therethrough and provide some degree of swivel range of motion. Such mounting joints are well known. One example of a suitable joint includes, but not limited to, a ball captured in a socket, the ball having a through bore to accept a bolt. The ball and socket provides for twisting/swiveling and lateral movement such as to accommodate for slight misalignment between the mounting of the upper coupling member 33 and the mounting of the lower coupling member 35.

The power-driven tonneau cover actuator 6 is mounted on the inside surface 19 of one of the upright truck body panels 12, 13. The drive unit 60 further comprises a motor mount plate 73 having mounting flanges 72. Appropriate fasteners are used through apertures in the flange 72 as shown in FIG. 4, to mount the motor mount plate 71 to the body panel 12, 13. Appropriate fasteners are used through drive mount apertures 73 to couple the drive unit 60 to the motor mount plate 71. The track 50 further comprises spaced-apart apertures 54 through which appropriate fasteners are used to secure the track 50 to the body panel 12, 13.

The track 50 is positioned on the inside surface 19 at an angle to the horizontal extending in an upward direction towards the hinged coupling 23. The angle between the track 50 and the horizontal is provided for the particular purpose of lifting the arm 30 as the trolley 40 advances along the track 50. An angle suitable for the particular purpose includes, but is not limited to, an angle between 15 and 45 degrees. The angle will be determined by many factors, some of which include, but are not limited to, the distance between the tonneau cover 20 and the track 50, the distance between the power-driven tonneau cover actuator 6 and the cover hinge 23, the opening height desired, and the length of the arm 30.

The arm 30 is coupled to the trolley 40 using a bolt 24 through the lower coupling member 35 and one of the one or more mounting apertures 43 provided in the mounting plate 42. The tonneau cover 20 is provided with a suitable mounting structure on the inside surface of the tonneau cover 20 adjacent an edge onto which the upper coupling member 33 is fastened. In one embodiment, the mounting structure is a mounting flange 22 having an aperture to accept a mounting bolt 24 therethrough, as shown in FIG. 6. In one embodiment, the mounting flange 22 comprises an L-shaped bracket fastened to the cover 20 by fasteners, adhesive, and the like.

The arm 30 is interconnected with the trolley 40 and cover 20 in a manner in which the upper and lower coupling 33, 35 can freely rotate in their mountings during the operation of the power-driven tonneau cover actuator 6. The coupling 35 must accommodate the rotation experienced when the trolley 40 travels forward to raise the tonneau cover 20 or travels rearward to lower the tonneau cover 20. Minor misalignment between the upper coupling member 33 and the lower coupling member 35 can be accommodated by the pivot and swivel features of the coupling members 33, 35 as described above. Other joints suitable for the particular purpose are anticipated.

In one embodiment, one power-driven tonneau cover actuator 6 is mounted on the inside surface 19 of each of opposite truck body panels 12, 13 in parallel relationship. Two power-driven tonneau cover actuators 6 provide additional support to the cover 20 and prevent any twisting or flexing of the tonneau cover 20 possibly experienced by using one power-driven tonneau cover actuator 6 at one edge of a not particularly rigid cover 20.

The tonneau cover 20 includes a hinge coupling 23 proximate the driver's cab 16 of the truck 10. The drive unit 60 is adjacent the tail gate 15 of the truck bed 11, and the arm 30 is positioned along an edge, or inset from an edge of the tonneau cover 20 and adapted to clear the rim 17 of the bed 11, by which the tonneau cover 20 is pivotally raised above the truck bed 11.

The drive unit 60 is electrically connected to a common or separate source of electrical power through a switch. For example, in one embodiment, the drive unit 60 is actuated by a conventional double pole, double throw center-off switch connected to the truck ground and 12V battery voltage. The switch can be located in the truck cab 16, elsewhere on the truck 10, as well as on a remote-controlled device. The electrical wiring 62 extends from the drive unit 60 to underneath the upper rim 17 of the bed side 12, 13 and along the rim 17 to the battery under the hood of the truck 10.

The drive unit 60 is controlled by the electrical switch to turn the gear 77 in a forward direction wherein the gear 77 advances the drive cable 80, and thus the trolley 40, in a forward direction. The trolley 40 carries the arm lower end 34 upward and forward and thereby raises the rear end 21 of the tonneau cover 20. The tonneau cover 20 is lowered by reversing the drive unit 60, turning the gear 77 in the reverse direction, retracting the drive cable 80, and thus moving the trolley 40 in a rearward direction. The trolley 40 carries the arm lower end 34 in a downward and rearward direction, thereby lowering the tonneau cover 20.

In one embodiment in accordance with the invention, the drive unit 60 is provided with a mechanical or magnetic clutch to hold the tonneau cover 20 open when the power to the drive unit 60 is removed. In this respect, when the tonneau cover 20 is raised by the arm 30 to a partial or fully raised position, the tonneau cover 20 will remain in that position. For example, a magnetic clutch in the drive unit 60 will prevent the tonneau cover 20 from moving as a result of the gear 77 remaining in a fixed position on opening the electrical circuit, thus holding the drive cable 80 in position. This feature yields an important safety benefit, as the tonneau cover 20 will not move unless power is provided to the drive unit 60.

The mechanical or magnetic clutch can also be used to hold the tonneau cover 20 closed when the power to the drive unit 60 is removed when the tonneau cover 20 is lowered. This feature yields an important security benefit wherein the tonneau cover 20 cannot be opened unless power is provided to the drive unit 60.

Power Window

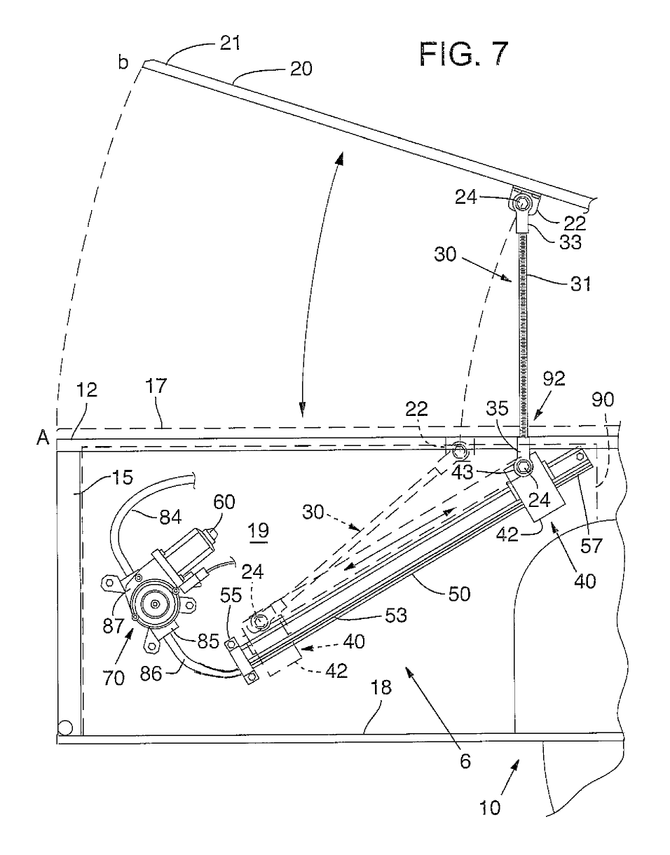

FIG. 8 is a perspective view of a power window actuator 8 in a door 92 of a motor vehicle 90 in accordance with another embodiment of the present invention. The power window actuator 8 comprises a power drive 4, substantially as shown in FIG. 2A, with a window flange 44 suitable to couple with a window 94. The power window actuator 8 is secured to a door panel 96 or other body panel. The track 50 is positioned substantially vertically, with the track lower end 55 lower than the track upper end 57. The drive unit 60 advances the trolley 40 along the track 50 from the track lower end 55 to the track upper end 57, which raises the window 94 to the closed position. Reversing the direction of travel of the trolley 40 from the track upper end 57 to the track lower end 55 lowers the window 94 to the open position.

The drive unit 60 is mounted to the door panel 96 on either side of the track 50. The drive unit 60 further comprises mounting flanges 72, as shown in FIG. 4. Appropriate fasteners are used through apertures in the flanges 72 to mount the drive unit 60 to the door panel 96. The track 50 further comprises spaced-apart apertures 54 through which appropriate fasteners are used to secure the track 50 to the door panel 96.

The drive unit 60 is electrically connected to a common or separate source of electrical power through a switch. For example, in one embodiment, the drive unit 60 is actuated by a conventional double pole, double throw center-off switch connected to the motor vehicle ground and 12V battery voltage. The switch can be located on the inside door panel.

The drive unit 60 is controlled by the electrical switch to turn the gear 77 in a forward direction wherein the gear 77 advances the drive cable 80, and thus the trolley 40, upward to lift the window. The window is lowered by reversing the drive unit 60, turning the gear 77 in the reverse direction, retracting the drive cable 80, and thus moving the trolley 40 downward. The trolley 40 carries the window 94 downward, thereby lowering the window 94.

Although specific embodiments have been illustrated and described herein for purposes of description of the preferred embodiment, it will be appreciated by those of ordinary skill in the art that a wide variety of alternative and/or equivalent implementations calculated to achieve the same purposes may be substituted for the specific embodiment shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed:

1. A power drive and motor vehicle component, the power drive comprising:
a track including a track lower end and a track upper end, the track including a cable guide extending from the track lower end for at least a portion of a length of the track;
a trolley adapted for sliding engagement with the track and adapted to traverse at least a portion of the length of the track, the trolley adapted to couple with the motor vehicle component;
a drive cable having a proximal end and a distal end, the drive cable proximal end coupled to the trolley, the cable guide adapted to accept and guide the drive cable; and
a drive unit adapted to engage the drive cable adjacent the drive cable distal end to impart forward and reverse motion to the drive cable driving the trolley along the track,
the motor vehicle component comprising:
a window, and
a window flange coupled to the window, the trolley coupled to the window flange.

2. The power drive and motor vehicle component of claim 1, wherein the drive unit is coupled to the track lower end.

3. The power drive and motor vehicle component of claim 1, further comprising:
an intermediate cable sleeve having a first intermediate sleeve end and a second intermediate sleeve end and a lumen therethrough, the lumen adapted to slidingly receive the drive cable therein, the first intermediate sleeve end coupled to the cable guide at the track lower end and the second intermediate sleeve end coupled to the drive unit wherein the drive unit and the track are independently positionable.

4. The power drive and motor vehicle component of claim 1, further comprising a gear, the drive unit comprising a drive shaft coupled to the gear, wherein the gear is driven by an electric motor by way of the drive shaft, the drive cable comprising a helical coil, wherein the trolley is driven along the track by the engagement of the gear and the helical coil.

5. The power drive and motor vehicle component of claim 3, further comprising a distal drive cable sleeve coupled to a drive distal end of the drive unit, the distal cable sleeve adapted to receive the drive cable when the drive cable is retracted from the cable guide.

6. The power drive and motor vehicle component of claim 5, wherein the intermediate cable sleeve comprises substantially flexible tubing.

7. The power drive and motor vehicle component of claim 5, wherein the intermediate cable sleeve comprises substantially rigid tubing.

8. The power drive and motor vehicle component of claim 3, the drive cable further comprising a core insert having bristles, the core insert disposed in the center of the helical coil, the bristles extending through the openings of the helical coil.

9. The power drive and motor vehicle component of claim 3, further comprising a switch adapted to be controlled by a wireless transmitter, the switch adapted to operate the drive unit.

10. A power drive and motor vehicle component, the power drive comprising:
a track including a track lower end and a track upper end, the track including a cable guide extending from the track lower end for at least a portion of a length of the track;
a trolley adapted for sliding engagement with the track and adapted to traverse at least a portion of the length of the track;
a drive cable having a proximal end and a distal end, the drive cable proximal end coupled to the trolley, the cable guide adapted to accept and guide the drive cable; and
a drive unit adapted to engage the drive cable adjacent the drive cable distal end to impart forward and reverse motion to the drive cable driving the trolley along the track,
the motor vehicle component comprising:
a window flange suitable for coupling with a window, the trolley coupled to the window flange.

11. The power drive and motor vehicle component of claim 10, wherein the drive unit is coupled to the track lower end.

12. The power drive and motor vehicle component of claim 10, further comprising:
an intermediate cable sleeve having a first intermediate sleeve end and a second intermediate sleeve end and a lumen therethrough, the lumen adapted to slidingly receive the drive cable therein, the first intermediate sleeve end coupled to the cable guide at the track lower end and the second intermediate sleeve end coupled to the drive unit wherein the drive unit and the track are independently positionable.

13. The power drive and motor vehicle component of claim 12, further comprising a gear, the drive unit comprising a drive shaft coupled to the gear, wherein the gear is driven by an electric motor by way of the drive shaft, the drive cable comprising a helical coil, wherein the trolley is driven along the track by the engagement of the gear and the helical coil.

14. The power drive and motor vehicle component of claim 12, further comprising a distal drive cable sleeve coupled to a drive distal end of the drive unit, the distal cable sleeve adapted to receive the drive cable when the drive cable is retracted from the cable guide.

15. The power drive and motor vehicle component of claim 13, wherein the intermediate cable sleeve comprises substantially flexible tubing.

16. The power drive and motor vehicle component of claim 14, wherein the intermediate cable sleeve comprises substantially rigid tubing.

17. The power drive and motor vehicle component of claim 14, the drive cable further comprising a core insert having bristles, the core insert disposed in the center of the helical coil, the bristles extending through the openings of the helical coil.

18. The power drive and motor vehicle component of claim 12, further comprising a switch adapted to be controlled by a wireless transmitter, the switch adapted to operate the drive unit.

19. A power window actuator for opening and closing a window on a motor vehicle, comprising;
a power drive, comprising:
a track coupled to a door or body panel of the motor vehicle, the track having a track lower end and a track upper end, having a cable guide along the length of the track;
a trolley adapted for sliding engagement with the track and adapted to traverse at least a portion of the length of the track, the trolley adapted to couple with the window;
a drive cable having a proximal end and a distal end, the proximal end coupled to the trolley;
an intermediate cable sleeve having a first intermediate sleeve end and a second intermediate sleeve end, the first intermediate end coupled to the cable guide at the track lower end;
a drive unit coupled to the second intermediate sleeve end, the drive unit adapted to engage the drive cable to impart forward and reverse motion thereto driving the trolley along the track, the intermediate cable sleeve comprising a flexible material allowing for independent placement of the drive unit and the track by selectively bending the intermediate cable sleeve.
